(19) United States
(12) Patent Application Publication
(10) Pub. No.: US 2009/0277696 A1
(43) Pub. Date: Nov. 12, 2009

(54) GRADIENT SENSORS

(76) Inventors: Joseph K. Reynolds, Sunnyvale, CA (US); Kirk Hargreaves, Mountain View, CA (US)

Correspondence Address: SYNAPTICS C/O WAGNER BLECHER LLP, 123 WESTRIDGE DRIVE, WATSONVILLE, CA, 95076, US

(21) Appl. No.: 12/195,351

(22) Filed: Aug. 20, 2008

Related U.S. Application Data
(60) Provisional application No. 61/052,107, filed on May 9, 2008.

(51) Int. Cl. G06F 3/044

(52) U.S. Cl. 178/18.06

(57) ABSTRACT

A capacitive sensing device for sensing a user input comprises a resistive sheet, a plurality of electrodes, at least one sensing node, and at least one charge integrator. The plurality of electrodes is disposed on a plurality of edge regions of the resistive sheet and configured for applying excitation voltages to the resistive sheet such that a substantially steady state voltage gradient is established on the resistive sheet. At least one of the sensing nodes is disposed on at least one of the plurality of edge regions of the resistive sheet and configured for sensing a resulting charge on the resistive sheet after establishment of the substantially steady state voltage gradient and a cessation of application of the excitation voltages. At least one of the charge integrators is coupled to the at least one sensing node and configured for measuring the resulting charge to produce a measurement.

### RELATED U.S. APPLICATION (PROVISIONAL)

This non-provisional application claims priority to the co-pending provisional patent application, Ser. No. 61/052,107, Attorney Docket Number SYNA-20070309-A1.PRO, entitled “Gradient Sensors,” with filing date May 9, 2008, and assigned to the assignee of the present invention, which is herein incorporated by reference in its entirety.

### BACKGROUND

Sensing devices, otherwise known as touch sensing devices or proximity sensors are widely used in modern electronic devices. A capacitive sensing device is often used for touch based navigation, selection, or other input, in response to a finger, stylus, or other object being placed on or in proximity to a sensor of the capacitive sensing device. In such a capacity, capacitive sensing devices are often employed in computers (e.g. notebook/laptop computers), media players, multi-media devices, remote controls, personal digital assistants, smart devices, telephones, and the like. Un-patterned sheet sensors (both capacitive and resistive) are often employed as a simple and economical method means for implementing attractive sensors for sensing contact, touch, and/or proximity based inputs.

Typical capacitive sheet sensors suffer from a limitation in they cannot distinguish a large hovering object from a smaller object which is in contact with the capacitive sheet sensor. This is because the sheet is uniformly sensitive to capacitance. Additionally, many capacitive sheet sensors require multiple sensing points and/or a very thin and easily damaged contact layer. Thus, despite simplicity and low cost, such limitations curtail usefulness of typical capacitive sheet sensors.

Typical resistive sheet sensors have at least two overlapped layers. When contacting a front layer of the overlapped layers, such as with a stylus, conduction occurs between the layers and transfers a voltage from one layer to another at the point of contact. This voltage is used to determine one or more components of the contact location. A typical issue with resistive sheet sensors is that wear and cracking occurs in high use areas due to the contact or pressing forces which deflect and bend the two layers into contact. Because a gap, such as an air gap, is required between the layers, cracking and bending often cause failures of resistive sheet sensors. Control of the gap requires more complex procedures for acceptable yield.

### SUMMARY

A capacitive sensing device for sensing a user input comprises a resistive sheet, a plurality of electrodes, at least one sensing node, and at least one charge integrator. The plurality of electrodes is disposed on a plurality of edge regions of the resistive sheet and configured for applying excitation voltages to the resistive sheet such that a substantially steady state voltage gradient is established on the resistive sheet. At least one of the sensing nodes is disposed on at least one of the plurality of edge regions of the resistive sheet and configured for sensing a resulting charge on the resistive sheet after establishment of the substantially steady state voltage gradient and a cessation of application of the excitation voltages. At least one of the charge integrators is coupled to the at least one sensing node and configured for measuring the resulting charge to produce a measurement.

A user input can be from an input object or objects which is/are contacting and/or in proximity of the capacitive sensing device. An input object may comprise an object such as portion of a hand, a finger, multiple fingers, stylus, multiple styli, other input object as known in the art and/or a combination such input objects.

### BRIEF DESCRIPTION OF THE DRAWINGS

The accompanying drawings, which are incorporated in and form a part of this specification, illustrate embodiments of the technology for gradient sensors and, together with the description, serve to explain principles discussed below:

FIG. 1A is block diagram of a capacitive sensing device, according to one embodiment.

FIG. 1B is block diagram of a capacitive sensing device in conjunction with a guard, according to one embodiment.

FIG. 2 is a schematic view of an example capacitive sensing device, according to one embodiment.

FIG. 3 is a schematic view of an example capacitive sensing device, according to one embodiment.

FIG. 4 is a timing diagram for an example capacitive sensing device, according to one embodiment

FIG. 5A is a schematic view of an example capacitive sensing device, according to one embodiment.

FIG. 5B is a schematic view of an example capacitive sensing device, according to one embodiment.

FIG. 6A is a schematic view of an example capacitive sensing device, according to one embodiment.

FIG. 6B is a schematic view of an example capacitive sensing device, according to one embodiment.

FIG. 7 is a schematic view of an example capacitive sensing device, according to one embodiment.

FIG. 8 is a schematic view of an example resistive sheet configuration, according to one embodiment.

FIG. 9 is a schematic view of an example resistive sheet configuration, according to one embodiment.

FIG. 10 shows an example electronic apparatus configured with a sensing device which capacitively determines position information about a user input relative to a resistive sheet.

FIG. 11 is a flow diagram of a method for capacitively determining position information about a user input relative to a resistive sheet, according to one embodiment.

FIG. 12 shows a schematic of an example differential charge integrator used as a synchronous demodulator, according to one embodiment.

FIG. 13 is a flow diagram of a method for creating a capacitive sensing device, according to one embodiment.

The drawings referred to in this description should not be understood as being drawn to scale unless specifically noted.

### DETAILED DESCRIPTION

Reference will now be made in detail to embodiments of the presented technology, examples of which are illustrated in the accompanying drawings. While the presented technology will be described in conjunction with embodiments, it will be understood that the descriptions are not intended to limit the presented technology to these embodiments. On the contrary, the descriptions are intended to cover alternatives, modifications and equivalents, which may be included within the spirit and scope as defined by the appended claims. Furthermore, in the following detailed description, numerous specific details are set forth in order to provide a thorough understanding of the presented technology. However, it will be obvious to one of ordinary skill in the art that the presented technology may, in some embodiments, be practiced without these specific details. In other instances, well known methods, procedures, components, and circuits have not been described in detail as not to unnecessarily obscure aspects of the presented technology.

### Overview of Discussion

The capacitive sensing devices described herein exhibit some structural similarities to both conventional capacitive sheet sensors and resistive sheet sensors. However, it will be apparent that the sheet sensors described herein also have structural and operational differences in comparison to conventional sheet sensors, which reduce or eliminate some complications, limitations, and often undesirable characteristics found in existing capacitive sheet sensors and in existing resistive sheet sensors.

In brief, the capacitive sensing devices described herein allow multiple spatial voltage gradient distributions or modes to be excited in an un-patterned sheet sensor. By exciting different voltage gradients in the resistive sheet a small object, such as a finger, can be distinguished from a larger object, such as a palm, based on the total charge extracted from the sheet. Similarly, in some embodiments hovering objects can be distinguished from objects in contact. These multiple voltage gradients are excited by a plurality of electrodes (2 or more) which are disposed on edge regions of the sheet sensor. An edge region may be near an edge of the substrate, near an edge of a visible region of the device, or simply near an edge of a functional sensing area. Moreover, many of these voltage gradients cause different regions of the capacitive sensing device to develop varying levels of capacitive charge relative to other areas, thus allowing non-uniform sensitivity to user input. Charge is extracted using as little as a single sensing node coupled with as little as single charge integrator, instead of the multiple sensor nodes and charge integrators required by existing capacitive sheet sensors. The capacitive sensing devices described herein can be configured to provide one-dimensional, two-dimensional, or more dimensional sensing of objects. For example, sensing can be single contact, multiple contacts, proximity sensing and/or other types of sensing as known in the art. The capacitive sensing devices described herein can be used to implement sensing devices such as a scroll bar, a touch pad, or a touch screen.

Discussion will begin with a description of a block diagram of capacitive sensing device which uses a resistive sheet as a gradient sensor. Numerous schematics of example capacitive sensing devices will then be described. Techniques for analog to digital conversion using components of a capacitive sensing device will be discussed. Some example sheet sensor layouts will then be described. An example electronic apparatus employing a capacitive sensing device will then be described. Discussion will then be directed toward an example method for capacitively determining position information about a user input relative to a resistive sheet. Finally, an example method for creating a capacitive sensing device will be described.

### Capacitive Sensing Device

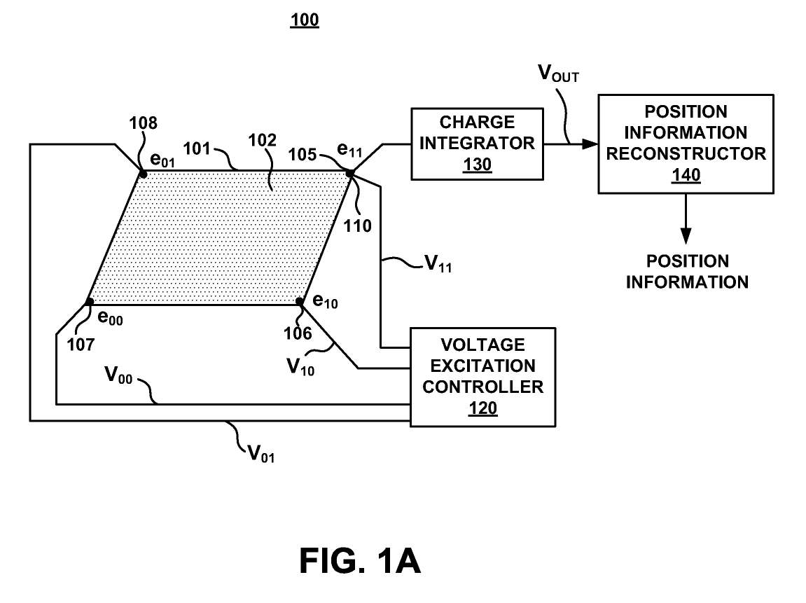

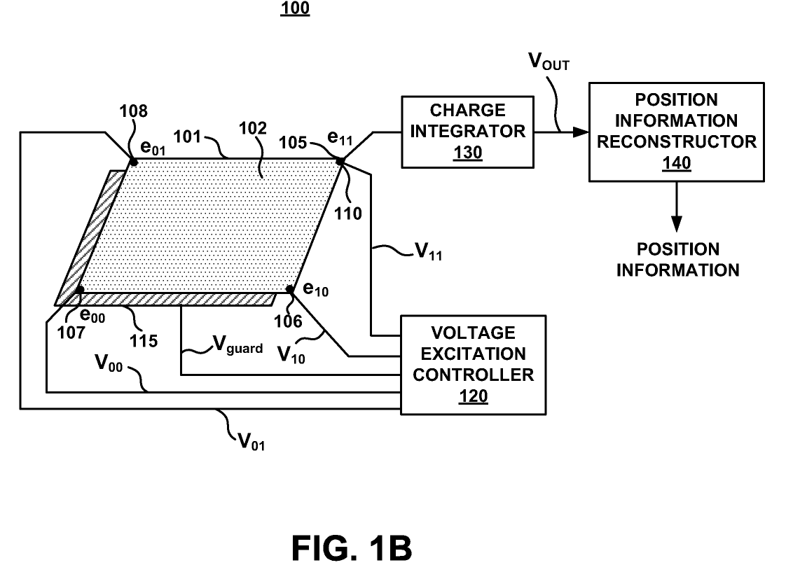

FIG. 1A is a block diagram of a capacitive sensing device 100, according to one embodiment. Capacitive sensing device 100 is for sensing a user input, such as proximity or contact based input performed with one or more user digits, a palm, and/or a stylus or other device used for input. As shown in FIG. 1A, capacitive sensing device 100 comprises a resistive sheet 101, a plurality of electrodes, 105, 106, 107, and 108, a sensing node 110, a voltage excitation controller 120, a charge integrator 130, and in some embodiments, a position information reconstructor 140. In embodiments where position information reconstructor 140 is not included, a voltage (V_{OUT}) is provided as an output. This output voltage can then be provided to a device, processor, module, or mechanism which operates to perform a function such as that performed by position information reconstructor 140.

Resistive sheet 101 comprises, in one embodiment, an unpatterned resistive material. For example, resistive sheet 101 can be comprised of a resistive film applied over a substrate such as glass, plastic, or other material. In one embodiment, resistive sheet 101 comprises a coating of indium tin oxide (ITO) deposited on a substrate such as glass or plastic and mounted above the viewable surface of a Liquid Crystal Display. It is appreciated that such a coating is thick enough to easily withstand substantial repetitive contact base user inputs occurring on either of the faces of the substrate. A first face represented by surface 102 of resistive sheet 101 is used for sensing input, such as proximity or touch input of a user. As shown in FIG. 1B. In one embodiment, a guard electrode 115 in the form of a conductive layer may be disposed underneath the face represented by surface 102 (e.g., on the opposing face of the substrate upon which resistive sheet 101 is disposed or on a second substrate behind the substrate upon which resistive sheet 101 is deposited). In FIG. 1B, a second substrate is utilized for guard electrode 115. As shown, in one embodiment, voltage excitation controller 120 provides a guard voltage, V_{guard}, to guard electrode 115.

Referring again to FIG. 1A, a plurality of electrodes is disposed on a plurality of edge regions of resistive sheet 101. In FIG. 1A, electrodes 105, 106, 107, and 108 represent the plurality of electrodes. The plurality of electrodes is disposed in edge regions such as peripheral side edge regions and/or corner edge regions of resistive sheet 101. As shown, in FIG. 1A, electrodes 105-108 are disposed in the four corners of resistive sheet 101. It is appreciated that in other embodiments a greater or lesser number of electrodes may be disposed in these or other edge regions. For example, two, six, or eight electrodes may be disposed upon edge regions in other embodiments. The edge region may be near an edge of the substrate, near an edge of a visible region of the device, or simply near an edge of the functional sensing area of position information reconstructor 140. The plurality of electrodes 105-108, serve as application points used to apply excitation voltages, such as V₀₀, V₀₁, V₁₀, V₁₁, to resistive sheet 101. These excitation voltages are applied to establish a substantially steady state voltage gradient on resistive sheet 101. By altering various parameters such as electrode selection, timing of voltage application at electrodes, and/or variation in the voltage applied, a variety of substantially different steady state voltage gradient configurations can be established on resistive sheet 101. By way of example and not of limitation, when viewed across resistive sheet 101, such substantially different voltage gradients can be, for example among other shapes, a uniform (constant) voltage gradient, a hump (or saddle) shaped voltage gradient, a ramp shaped voltage gradient in various directions.

An electrode may comprise the same resistive material as resistive sheet 101, a conductive ink, or some other conductive material (e.g., a metal). Moreover, in one embodiment, one or more of the edge regions may be configured to have a lower average sheet resistance than a central surface region of the resistive sheet. For example, a conductive ink may be printed in one or more corner regions and/or one or more peripheral side edge regions of resistive sheet 101. By lowering the resistance in edge regions of resistive sheet 101, a more uniform voltage gradient can be established across resistive sheet 101. This uniformity of the voltage gradient simplifies the processing required to determine the position of an object relative to resistive sheet 101. Alternately the resistive sheet material on the sheet can be patterned to increase the sheet resistance in other areas or otherwise vary the sheet resistance at selected locations on the sheet.

At least one sensing node, such as sensing node 110, is disposed on at least one of the plurality of edge regions of resistive sheet 101. In embodiments described herein, only a single sensing node is required, but more may be utilized. It is appreciated that a sensing node may be physically similar to, identical to, or one in the same as an electrode, such as any one of electrodes 105-108. For example, as shown in FIG. 1A, electrode 105 also serves as sensing node 110 and thus electrode 105 and sensing node 110 are commonly located. After establishment of a steady state voltage gradient and application of the excitation voltages has ceased (typically substantially simultaneously) on all electrodes, a sensing node, such as sensing node 110 is used for sensing a resulting charge on resistive sheet 101. A sensing node, such as sensing node 110, may comprise the same resistive material as resistive sheet 101, a conductive ink, or some other conductive material.

Voltage excitation controller 120 is used to control application of excitation voltages, such as V₀₀, V₀₁, V₁₀, and V₁₁, to resistive sheet 101. In FIG. 1A, V₀₀, V₀₁, V₁₀, and V₁₁ represent the applied voltages, while e₀₀, e₀₁, e₁₀, and e₁₁ represent the effective voltages present at electrodes 105, 106, 107, and 108 on resistive sheet 101. Voltage excitation controller 120 is also used to cease the application of such excitation voltages after a settling time, such as one or more RC time constants of resistive sheet 101, has passed so that substantially steady state voltage gradient has been given sufficient time to be established on resistive sheet 101. For example, in one embodiment, voltage excitation controller 120 substantially simultaneously ceases the application of excitation voltages V₀₀, V₀₁, V₁₀, V₁₁, to resistive sheet 101 after establishment of a substantially steady state voltage gradient on resistive sheet 101.

Generally, the time period for substantially simultaneously ceasing application of excitation voltages is very short. In one embodiment, what is meant by substantially simultaneously ceasing application of excitation voltages, is that excitation voltage at each electrode (e.g., 105, 106, 107, 108) are all shut off or ceased within a time period that is substantially shorter than one RC time constant of resistive sheet 101. Consider an example where the time period of the substantially simultaneous ceasing of all the excitation voltages is a time of approximately ten percent (or less) of one RC time constant of resistive sheet 101, and where resistive sheet 101 is a typical ITO sheet with a sheet resistance of 300 Ω/□ and a low background capacitance of 300 pF. In such an embodiment, the RC time constant of resistive sheet 101 would be on the order of 90 nanoseconds. Thus, following the example described above, voltage excitation controller 120 would cease the application of excitation voltages V₀₀, V₀₁, V₁₀, and V₁₁ in approximately 9 nanoseconds or less of one another.

Voltage excitation controller 120 is also used to selectively control application of excitation voltages (such as V₀₀, V₀₁, V₁₀, V₁₁) through the plurality of electrodes (e.g., 105, 106, 107, 108) to establish a plurality of substantially different steady state voltage gradients on resistive sheet 101. For example, selective control can comprise altering various parameters such as electrode selection, timing of voltage application at electrodes, and/or variation in the voltage applied, in order to achieve establishment of a variety of substantially different steady state voltage gradient configurations on resistive sheet 101. In an example of electrode selection, excitation voltages can be applied to two electrodes 105 and 107, but not to two other electrodes 106 and 108. In an example of variation of timing, excitation voltages can be applied to electrodes 107 and 108 a short time (for example 5 RC time constants of resistive sheet 101) before excitation voltages are applied to electrodes 105 and 106. In an example of voltage variation, a voltage of −5 volts can be applied to electrodes 107 and 108 and a voltage of +5 volts can be applied to electrodes 105 and 106. The voltages applied on electrodes 105 and 106 may only be for 1 RC time constant before the application of voltages to all electrodes is ceased. It is appreciated that these and other parameters may be altered independently or in conjunction with one another. Moreover, it is appreciated that a greater number of substantially steady state voltage gradient configurations can be achieved when a larger number of electrodes are utilized on a resistive sheet. For example, more steady state voltage gradient variations can be achieved with four or six electrodes than with two electrodes.

By applying separate and often different voltages to two or more electrodes (e.g., 105, 106, 107, and 108) coupled with resistive sheet 101 and allowing for the system to settle into a substantially steady state, some voltage gradient is established across resistive sheet 101 (where the voltage gradient is the difference in voltage across a distance on the resistive sheet), This difference in voltage could be close to zero (as in zero slope (e.g. if all at 5 volts)) such that the charge on similar areas of similar capacitance would contribute similar charge to the total sheet. The difference in voltages could be equal and opposite such that charge on similar areas of similar capacitance could contribute opposing charges to the total sheet. The total voltage gradient, along with the total background capacitance generates a total charge on resistive sheet 101. It is appreciated, however, that even if the voltages at opposite ends of resistive sheet 101 are opposite, the voltages in other areas may be at the same or different levels from either of the opposing ends.

Charge integrator 130 is used to produce a measurement (V_{OUT}) of the charge on resistive sheet 101. As shown in FIG. 1A, charge integrator 130 is coupled to sensing node 110. As previously described, in one embodiment, only one charge integrator and one sensing node are required for operation of capacitive sensing device 100. In one embodiment where multiple charge integrators 130 are utilized, each of the multiple charge integrators can be coupled to a different sensing node 110 or they can all be coupled to the same sensing node 110. It is appreciated that a charge integrator, such as charge integrator 130, may be implemented in a number of ways, several of which are described herein. For example, charge integrator 130 can be implemented comprising a capacitor and a switch or comprising a capacitor and an operational amplifier. It is appreciated that in some embodiments, that the output of charge integrator 130 is further processed, such as by filtering and/or by an analog to digital converter. In such embodiments, portions of charge integrator 130 (such as a capacitor or operational amplifier) can be used to perform or assist with the performance of the filtering or analog to digital conversion.

With reference to FIG. 1A, when voltage excitation controller 120 ceases application of excitation voltages V₀₀, V₀₁, V₁₀, V₁₁ substantially simultaneously, a charge is trapped on resistive sheet 101. An object (such as a finger) in contact with or proximate (e.g. hovering above) surface 102 changes the charge depending on the voltage at the region of resistive sheet 101 which the object is in contact with or hovering above. Charge integrator 130 is then connected to resistive sheet 101 (e.g., via sensing node 110) long enough (typically several RC time constants) to substantially drain off the charge. In the previous example where resistive sheet 101 is an ITO sheet with a sheet resistance of 300 Ω/□ and a low background capacitance of 300 pF, 1 microsecond is 11.1 RC time constants, which is long enough to drain off 99.998% of the charge on resistive sheet 101. As this charge is drained off, charge integrator 130 integrates the charge into a voltage V_{OUT}, which can then be used to reconstruct the position of a contact or of an object in proximity to resistive sheet 101.

For example, in one embodiment, V_{OUT} is provided to position information reconstructor 140. Position information reconstructor 140 uses the measurement produced by charge integrator 130 to reconstruct position information about an occurrence of a user input relative to surface 102 of resistive sheet 101. By comparing the charge for various combinations of (V₀₀-V₁₁) with and without the object, the position of the object can be determined. For example, by measuring the generated charge for various applied excitation voltages (used to establish a variety of different steady state voltage gradients, both in the presence and absence of a contacting/proximate input object such as a finger) position information reconstructor 140 can reverse calculate the position of the object. Depending upon the implementation, the position information can comprise one-dimensional and/or two-dimensional position information relative to surface 102. Also, with enough electrodes and steady state voltage gradient configurations, it is possible to determine other information about the object, such as determining the effective width of the object. By determining an effective width of an object, position information reconstructor 140 can distinguish between objects such as a palm, a finger, a stylus, styli, and/or multiple fingers. Further interpretation of this information may be used to implement modal effects (e.g., multi-finger gestures). Position information reconstructed by position information reconstructor 140 can include position information about an input object/objects, such as x-position relative to surface 102, y-position relative to surface 102, z-position relative to surface 102, size (e.g. width of an input object/object, and input object count). In the case of multiple input objects position information can include x-positions for multiple input objects, y-positions for multiple input objects, z-positions for multiple input objects, and sizes (widths) of multiple input objects.

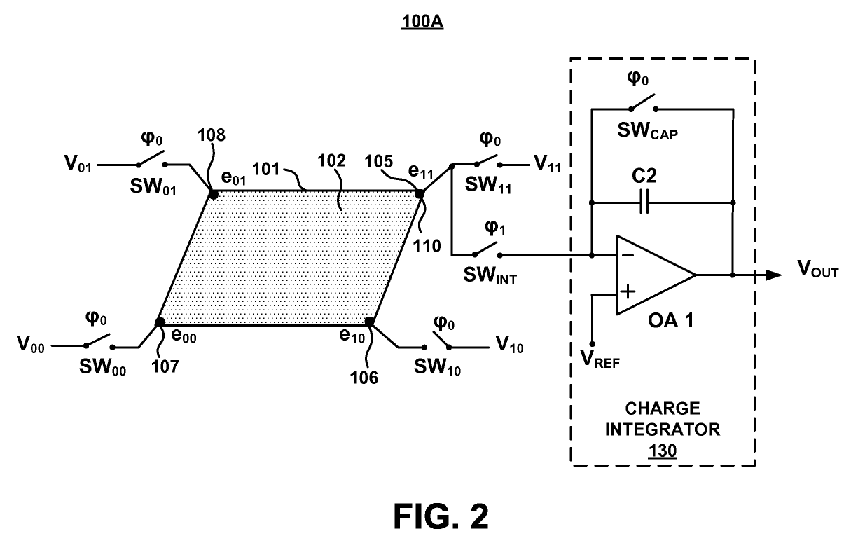

FIG. 2 is a schematic view of an example capacitive sensing device 100A, according to one embodiment. Capacitive sensing device 100A is one example implementation of capacitive sensing device 100. In this example, a particular implementation of charge integrator 130 has been shown, and for clarity, voltage excitation controller 120 and position information reconstructor 140 are not shown. In FIG. 2, charge integrator 130 includes capacitor C2 and operational amplifier OA1. The non-inverting input of OA1 is coupled with a reference voltage V_{REF}. C2 and switch SWCAP are coupled in parallel with one another between the output of OA1 and the inverting input of OA1. It is appreciated that in FIG. 2, like elements and figure numbers to those of FIG. 1A are the same as previously described. Note that V_{REF} may be fixed at many voltages (e.g. Ground, Vdd, Vdd/2, and the like), and may be varied even during a measurement or between measurements to improve the resolution of capacitive measurements.

In example capacitive sensing device 100A of FIG. 2, the four corners of resistive sheet 101 are driven by four separate voltages (V₀₀, V₀₁, V₁₀, V₁₁). At the same time, charge integration capacitor C2 is discharged via switch SW_{CAP}. Switches SW₀₀, SW₀₁, SW₁₀, and SW₁₁ represent switches which are then substantially simultaneously opened at time φ₀, thus disconnecting voltages V₀₀, V₀₁, V₁₀, V₁₁ from resistive sheet 101. Switch SW_{CAP} is also opened at this time, though it does not need to be simultaneous with SW₀₀-SW₁₁ being opened. SW_{INT} then closes at time φ₁, connecting charge integrator 130 (C2, OA1) to resistive sheet 101, collecting all of the charge on resistive sheet 101. The output, V_{OUT}, of charge integrator 130 represents a measurement of the charge and can then be further processed, such as by analog to digital conversion or filtering. This completes one cycle of measurement. When an object, such as a finger is detected, this process is then iteratively repeated to acquire a plurality of measurements. The voltages V₀₀, V₀₁, V₁₀, V₁₁ are changed or varied (in the manner previously described) from measurement to measurement in order to determine the position of the object relative to surface 102 of resistive sheet 101.

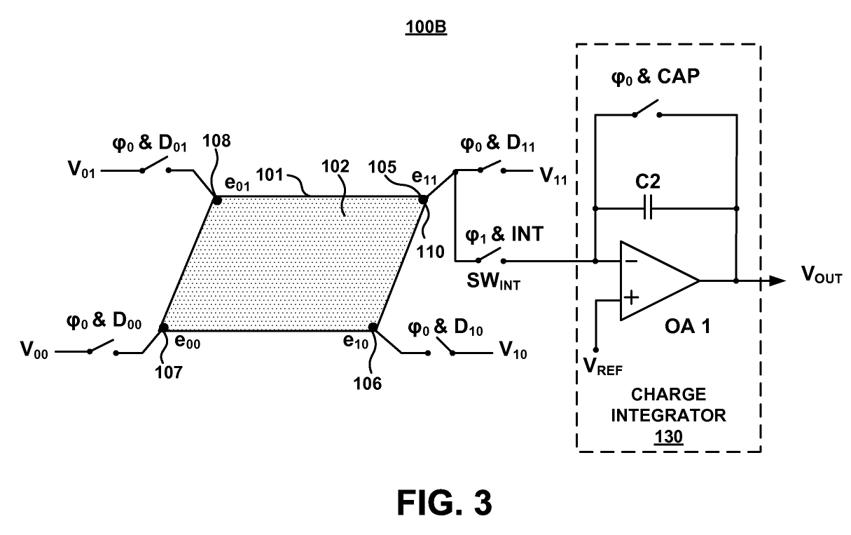

FIG. 3 is a schematic view of an example capacitive sensing device 100B, according to one embodiment. Capacitive sensing device 100B is one example implementation of capacitive sensing device 100. In this example, a particular implementation of charge integrator 130 has been shown, and for clarity, voltage excitation controller 120 and position information reconstructor 140 are not shown. In FIG. 3, charge integrator 130 includes capacitor C2 and operational amplifier OA1. The non-inverting input of OA1 is coupled with a reference voltage V_{REF}. C2 is coupled between the output of OA1 and the inverting input of OA1. Unless otherwise specified, it is appreciated that in FIG. 3, like elements and figure numbers to those of FIG. 1A are the same as previously described.

Typically, the non-inverting input of OA1 coupled with a reference voltage V_{REF} is held at a constant voltage. However, it is appreciated that the reference voltage may be changed to improve charge measurement. For example an offset charge could be removed from charge integrator 130 by changing Vref such that it more closely approximates the equilibrium voltage on the sheet after disconnecting voltages.

In example capacitive sensing device 100B device of FIG. 3, the four corners of resistive sheet 101 are driven by four separate voltages (V₀₀, V₀₁, V₁₀, V₁₁). Signal CAP is used to selectively allow C2 to be charged and discharged. Digital signals D₀₀, D₀₁, D₁₀, and D₁₁ represent signals which are used to selectively apply and cease application of voltages V₀₀, V₀₁, V₁₀, V₁₁ to the four corners of resistive sheet 101. At time φ₀, digital signals D₀₀, D₀₁, D₁₀, and D₁₁ substantially simultaneously disconnect voltages V₀₀, V₀₁, V₁₀, V₁₁ from resistive sheet 101. At this time, signal CAP also selectively discharges C2, though it does not need to be simultaneous with the ceasing of application of V₀₀, V₀₁, V₁₀, V₁₁. At time φ₁, signal INT selectively connects charge integrator 130 (C2, OA1) to resistive sheet 101 through switch SW_{INT}, collecting all of the charge on resistive sheet 101. The output or outputs (multiple outputs are not necessarily simultaneous outputs) represent a measurement of charge. For example, with reference to FIG. 3, V_{OUT} of charge integrator 130, represents a measurement of the charge and can then be further processed, such as by analog to digital conversion or filtering. This completes one cycle of measurement. When an object, such as a finger is detected, this process is then iteratively repeated to acquire a plurality of measurements, which can be differential measurements. The voltages V₀₀, V₀₁, V₁₀, V₁₁ are changed or varied (in the manner previously described) from measurement to measurement in order to determine the position of the object relative to surface 102 of resistive sheet 101 and/or to determine other information.

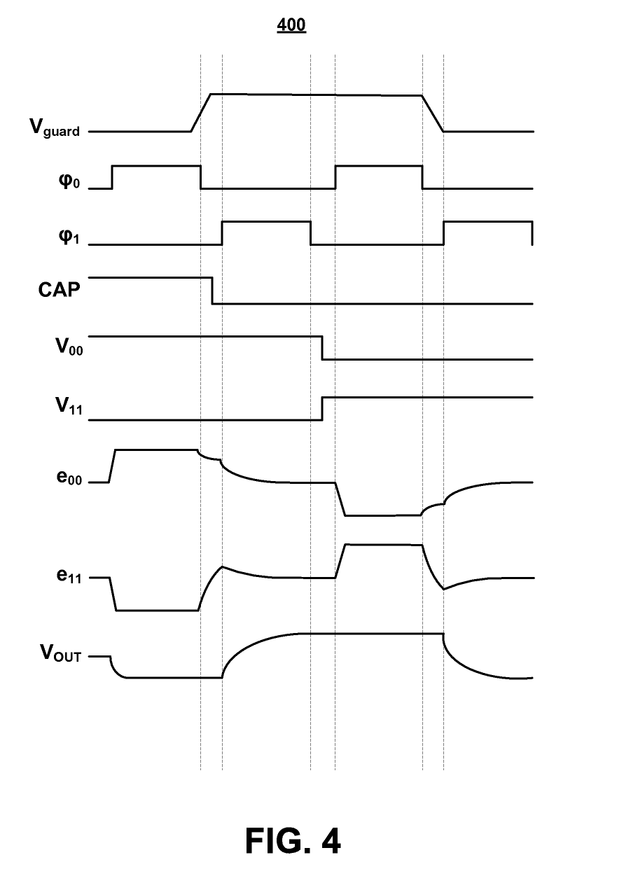

FIG. 4 is a timing diagram 400 for example capacitive sensing device 100B, according to one embodiment. In timing diagram 400, two cycles of measurement are shown for times φ_{0 and} φ₁. D₀₀ and D₁₁ are logical ‘1,’ (connecting V₀₀ and V₁₁ to the sheet) and D₀₁ and D₁₀ are logic ‘0,’ (disconnecting V₀₁ and V₁₀ from being driven). V₀₀ is driven with a high voltage when V₁₁ is driven with a low voltage. V₀₀ and V₁₁ reverse polarity between the two cycles shown and CAP is only at logical ‘1’ for the first cycle. In one embodiment, if there is a conductive layer beneath resistive sheet 101, it may be driven by a “guard” signal which is shown as V_{guard} in timing diagram 400. The guard signal voltage can be driven in numerous was, such as using switches or a digital input/output. In one embodiment, before or during φ₀, the guard signal is driven to its starting voltage by voltage excitation controller 120 and is then allowed to settle. After φ₀ and before the end of φ₁, the guard signal transitions to its ending voltage. This removes charge from the system or adds charge to the system on the resistive sheet relative to Vref. In one embodiment to avoid saturating charge integrator 130, transition in the guard voltage takes place before the start of φ₁.

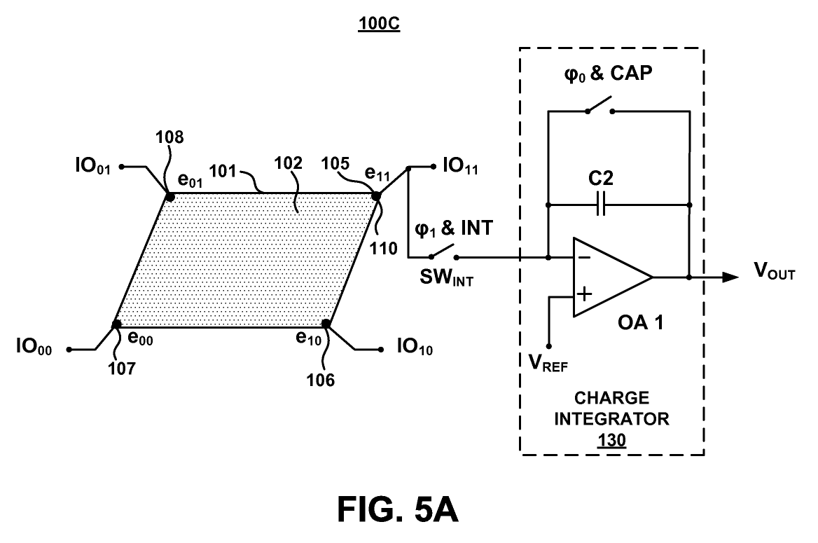

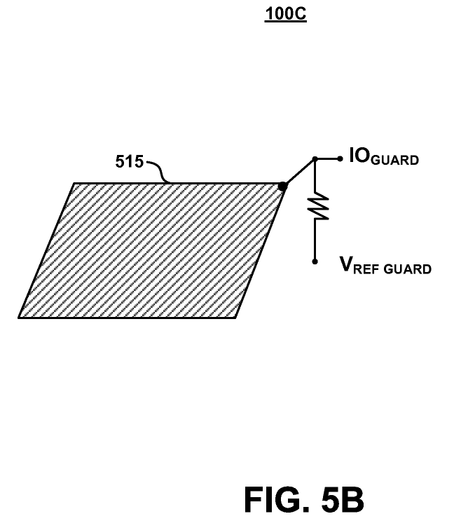

FIG. 5A is a schematic view of an example capacitive sensing device 100C, according to one embodiment. Capacitive sensing device 100C is one example implementation of capacitive sensing device 100. In this example, a particular implementation of charge integrator 130 has been shown, and for clarity, voltage excitation controller 120 and position information reconstructor 140 are not shown. Charge integrator 130 includes capacitor C2 and operational amplifier OA1. The non-inverting input of OA1 is coupled with a reference voltage V_{REF}. C2 is coupled between the output of OA1 and the inverting input of OA1. Unless otherwise specified, it is appreciated that in FIG. 5A, like elements and figure numbers to those of FIG. 1A, FIG. 1B, FIG. 2, and FIG. 4 are the same as previously described. As compared to example capacitive sensing devices 100A and 100B, in example capacitive sensing device 100C, switches SW₀₀-SW₁₁ and voltages V₀₀-V₀₁ are replaced by digital input/outputs IO₀₀, IO₀₁, IO₁₀, and IO₁₁. Each input/output is capable of driving to V_{CC} (logical ‘1’), V_{EE} (logical ‘0’), or high-impedance (‘Z’). IO₀₀-IO₀₁ can be inputs/outputs provided by a micro-controller, any tri-state driver, or a similar device. The 74LVC245 is one example of a suitable tri-state driver. The central consideration in the selection of a micro controller or tri-state driver is that it needs to be capable of switching all input/outputs from a low impedance output state to a high impedance, “Z,” input state more or less simultaneously.

In example capacitive sensing device 100C device of FIG. 5A, the four corners of resistive sheet 101 are driven either to power supply rail (V_{CC} or V_{EE}) or disconnected (high ‘Z’). This allows electrodes 105, 106, 107, and 108 in the corner regions to be driven and switched by digital input/outputs. In this example implementation, V_{REF} is somewhere between V_{CC} and V_{EE}, and in one implementation, for convenience, can be assumed to be Ground, with V_{CC} and V_{EE} referenced to it.

FIG. 5B is a schematic view of an example capacitive sensing device 100C, according to one embodiment. In the embodiment of FIG. 5B, a guard electrode 515 has been implemented. Guard 515, in one embodiment, as shown in FIG. 5B, may be implemented on the reverse side from surface 102 (FIG. 5A) of the substrate upon which resistive sheet 101 is disposed. A guard signal for driving may be generated using active components (e.g. an operational amplifier or a digital to analog converter). Alternately, a circuit can generate a guard signal using a single controller I/O (e.g., IO_{GUARD} and a passive impedance (as shown), using multiple I/Os coupled to guard electrode 515, or using multiple I/Os and/or multiple passive impedances. The passive impedances may be referenced to GND, a voltage reference (e.g., V_{REF GUARD}) or other variable voltages.

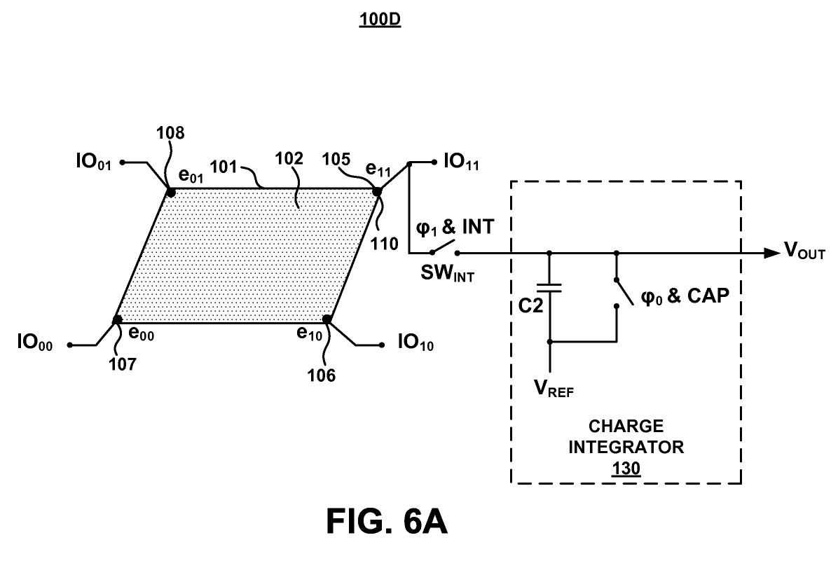

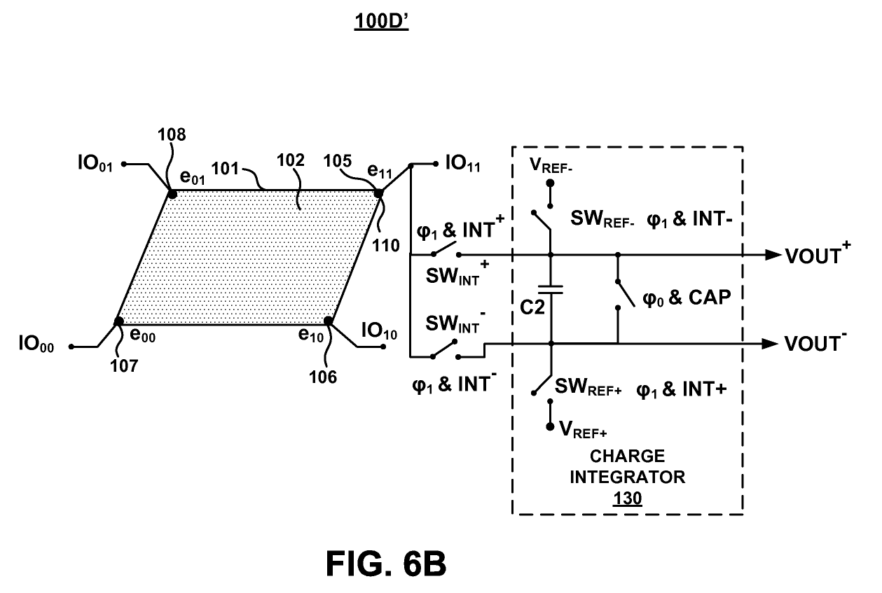

FIG. 6A is a schematic view of an example capacitive sensing device 100D, according to one embodiment. Capacitive sensing device 100D is one example implementation of capacitive sensing device 100. In this example, a particular implementation of charge integrator 130 has been shown, and for clarity, voltage excitation controller 120 and position information reconstructor 140 are not shown. Capacitive sensing device 100D is the same as capacitive sensing device 100C except that charge integrator 130 is implemented using a passive capacitor C2 as the integrator. Unless otherwise specified, it is appreciated that in FIG. 6A, like elements and figure numbers to those of FIG. 5A are the same as previously described. Using a passive capacitor as an integrator can result in a capacitive sensing device which has a lower cost due to using a lesser number of components and less expensive components. In this case, no active component, such as an operational amplifier is required to perform the function of charge integrator 130.

FIG. 6B is a schematic view of an example capacitive sensing device 100D, according to one embodiment. Capacitive sensing device 100D′ is one example implementation of capacitive sensing device 100. In this example, a particular implementation of charge integrator 130 has been shown, and for clarity, voltage excitation controller 120 and position information reconstructor 140 are not shown. Capacitive sensing device 100D is the same as capacitive sensing device 100C except that charge integrator 130 is implemented using a passive capacitor C2 as the integrator. Unless otherwise specified, it is appreciated that in FIG. 6B, like elements and figure numbers to those of FIG. 6A are the same as previously described. Using a passive capacitor as both an integrator and a demodulator can provide improved interference performance. In this case, charge can be accumulated differentially across the capacitor C2 during alternating positive and negative integrating cycles. During positive integration cycles, where for example a gradient is established by placing IO₀₀ in a high state and IO₁₁ in a low state (IO₀₁ and IO₁₀ may be at a high impedance state), the charge on the resistive sheet would be accumulated on capacitor C2 by closing SW_{INT+} during the period where both INT+ and φ₁ are high. During negative integration cycles, where for example a gradient is established by placing IO₀₀ in a low state and IO₁₁ in a high state (IO₀₁ and IO₁₀ may be at a high impedance state), the charge on the resistive sheet would be accumulated on capacitor C2 by closing SW_{INT-} during the period where both INT− and φ₁ are high. Notice that SW_{REF-} and SW_{REF+} are also closed on φ₁ and INT− or φ₁ and INT+ respectively, in order to integrate said differential charge. Also notice that the measurement of V_{OUT} maybe provided as a differential measurement between V_{OUT+} and V_{OUT-}. C2 can be discharged to V_{OUT} by closing a switch across C2 when both CAP and φ₀ are high.

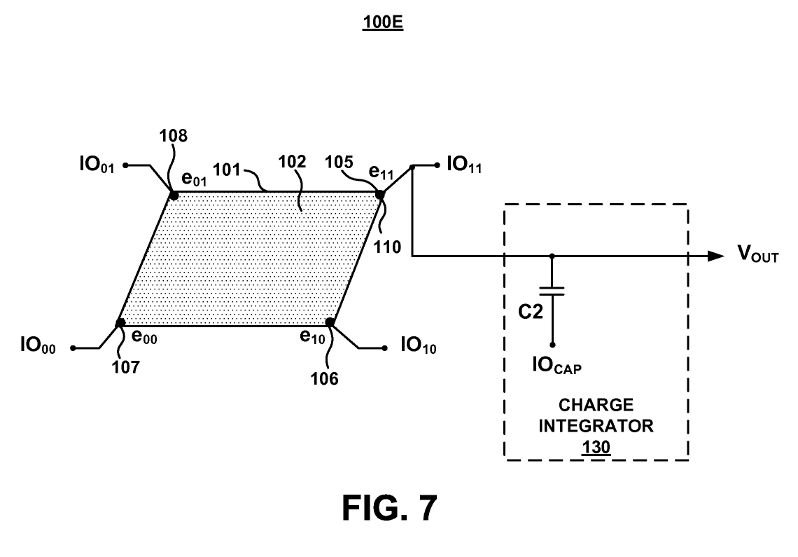

FIG. 7 is a schematic view of an example capacitive sensing device 100E, according to one embodiment. Capacitive sensing device 100E is one example implementation of capacitive sensing device 100. In this example, a particular implementation of charge integrator 130 has been shown, and for clarity, voltage excitation controller 120 and position information reconstructor 140 are not shown. Capacitive sensing device 100E is the same as capacitive sensing device 100D except that charge integrator 130 is implemented using a passive capacitor which is selectively discharged, charged, and/or coupled to resistive sheet 101 with a digital input/output IO_{CAP}. As previously described, such a digital input/output can be provided by a micro controller or a tri-state driver. Unless otherwise specified, it is appreciated that in FIG. 7, like elements and figure numbers to those of FIG. 5A are the same as previously described. By sequencing IO_{CAP} and IO₁₁ (in this example) between logical ‘0,’ logical ‘1,’ and ‘Z,’ charge may be transferred to and even accumulate onto capacitor C2. Table 1 shows an example of such sequencing to accumulate charge on passive capacitor C2 multiple times using digital input/outputs as selective controls.

TABLE 1
Example Use of Digital IOs to Charge a Passive Capacitor

| Step | IO₀₀₋₁₀ | IO₁₁ | IO_{CAP} | V_{OUT} | Description |
|---|---|---|---|---|---|
| 1 | 0 | 1 | 1 | — | IO_{CAP} discharged. Sheet sensor Charged. |
| 2 | 0 | 1 | Z | — | IO_{CAP} discharged. Sheet sensor Charged. |
| 3 | Z | Z | Z (0) | — | Disconnect IO's. Transition IO_{CAP} |
| | | | | | to 0, but leave disconnected. |
| 4 | Z | Z | 0 | V_{OUT1} | Integrate charge onto IO_{CAP}. |
| 5 | Z | Z | Z | NA | Disconnect integrator. |
| Repeat | Repeat | Repeat | Repeat | Repeat | Repeat from step 2 as needed and/or |
| | | | | | until a sensing action is completed. |

### Using a Charge Integrator as an Analog to Digital Converter

Charge integrator 130, either in the form of an active integrator or a passive capacitor, can be used as part of an analog to digital converter (ADC). For example, in one embodiment of a single slope ADC, charge is added (or subtracted) until the voltage on charge integrator 130 passes some threshold. The number of times that a charge is added/subtracted in order to pass the threshold equates to an analog to digital conversion value.

In an embodiment of a dual slope ADC, charge is added (or subtracted) on charge integrator 130 a predetermined number of times. Then the opposite action is performed, that is, charge is subtracted (or added if that is the opposite action) using a resistor, switched capacitor, current sink/source until the voltage on charge integrator 130 passes some threshold value. The time or number of times charge was removed (e.g. the opposite action) equates to an analog to digital conversion value. In an embodiment of a sigma delta ADC charge is placed on the integrator from the resistive sheet and the output V_{OUT} is quantized (e.g., compared to a reference) and the charge on the integrator is changed by a quantized amount depending on the quantization of V_{OUT}. The outputs of the quantization can be filtered to produce a sigma delta ADC result.

### Sheet Sensor Layout

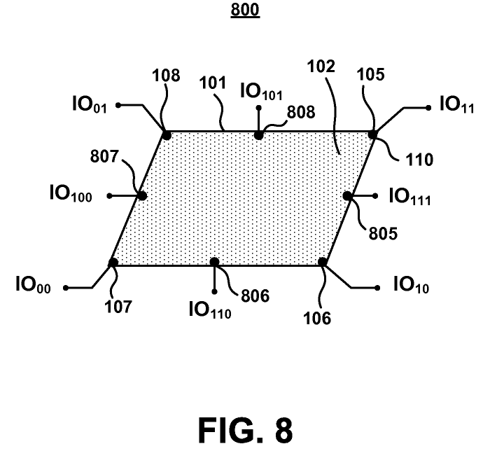

FIG. 8 is a schematic view of an example resistive sheet configuration 800, according to one embodiment. This is the same as the configuration shown in FIG. 6 except that extra electrodes 805, 806, 807, and 808 have been added at the mid-point of the peripheral side edge regions of resistive sheet 101 and that extra drive signals IO₁₁₁, IO₁₁₀, IO₁₀₀, and IO₁₀₁ have been coupled respectively to added electrodes 805, 806, 807, and 808.

By adding extra drive signals coupled to corresponding extra electrodes, several things may be accomplished. In one embodiment, for instance, by driving multiple signals on one side of resistive sheet 101 to the same voltage, the voltage gradient established on resistive sheet 101 is more uniform. For example, by driving IO₀₀, IO₁₀₀, and IO₀₁ to logical ‘1,’ IO₁₁₀ and IO₁₀₁ to ‘Z,’ and IO₁₁, IO₁₁₁, and IO₁₀ to logical ‘0,’ there is a fairly uniform voltage gradient from the left side of resistive sheet 101 to the right side of resistive sheet 101.

In another embodiment, by driving one side and two adjacent mid-points to the same voltage, the size of a contacting/or proximate objected may be discerned or differentiated. For instance, the difference between a finger and a palm may be discerned. As an example, by driving IO₀₀, IO₁₀₀, IO₀₁, IO₁₁₀ and IO₁₀₁ to logical ‘1,’ and IO₁₁, IO₁₁₁, and IO₁₀ to logical ‘0,’ any signal on the left side of resistive sheet 101 will be independent of position. Therefore, if a first position measurement indicates a finger on the left side of resistive sheet 101, and the above configuration is then quickly applied to resistive sheet 101 and a finger position indication is shown on the right side of resistive sheet 101, then the “finger” is extraordinarily wide, and thus must be either be a palm or a second finger on the right side of resistive sheet 101. Variations of this electrode drive configuration can be used to distinguish two fingers on both the left side and right side, both the top and bottom, or on opposing corners of resistive sheet 101. Drive signal asymmetries can also be leveraged in other similar ways to distinguish multiple fingers and to differentiate a finger/fingers from a palm.

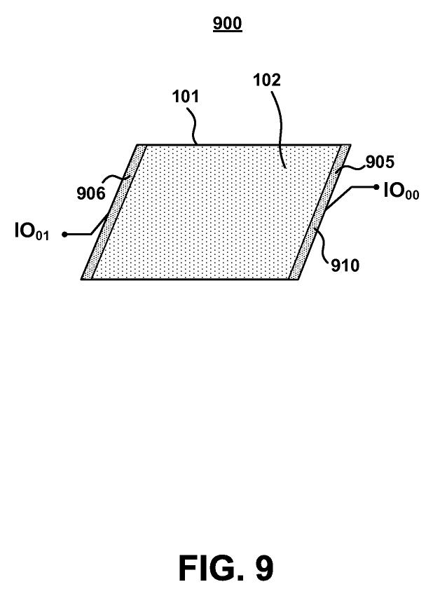

FIG. 9 is a schematic view of an example resistive sheet configuration 900, according to one embodiment. Configuration 900 shows a layout used for one-dimensional position determination of a contacting/proximate object relative to surface 102 of resistive sheet 101. Two electrodes 905 and 906 are utilized to apply voltages to resistive sheet 101. In this example, the voltages are applied and selectively controlled using digital input/outputs IO₀₀ and IO₁₁, in the manner previously described. Additionally as previously described, one of the electrodes doubles as a sensor node, in the form of sensor node 910. By only having wide contacts on two opposing edges of resistive sheet 101, a one-dimensional sensor is formed. In example configuration 900 a left to right one-dimensional position of a proximate/contacting object can be determined relative to its location contacting or hovering slightly above surface 102. Additionally, by making electrodes 905 and 906 wide instead of just point electrodes at the mid-points of peripheral side edge regions of resistive sheet 101, a greater control of the uniformity of the voltage gradient on sheet 101 is allowed. In this example, a more uniform voltage gradient allows for simplified processing in determining the position of an object relative to surface 102. In one embodiment, for example, electrodes 905 and 906 may be comprised of conductive ink such that they have a lower resistance than other portions of resistive sheet 101.

Measurements of the voltages that are excited by the electrodes can be made in order to improve the accuracy of the user input sensing. Different voltage gradients that are generated by non-idealities in the excitation or the resistance of the electrodes, which can affect the calculations for position reconstruction of the input. This can be done in a variety of ways including measuring the voltages at the electrodes where they are applied, measuring the voltage at an electrode where a voltage is not being applied, measuring the resulting charge without a finger present and comparing to a reference, and the like.

It is appreciated that in one embodiment, a guard electrode can be utilized in conjunction with configuration 900 (as well with other configurations shown and described herein). Guard electrode 515 of FIG. 5B provides one example of such a guard electrode. Guard electrode 115 of FIG. 1 provides another example of such a guard electrode. Vguard of FIG. 4 provides one example of a guard signal which could be driven on such a guard electrode.

Several different voltage gradients can be established using only two opposing electrodes for application of voltage. For example, by applying opposite voltages (e.g., V_{CC} and Gnd) to electrodes 905 and 906 on opposing sides of resistive sheet 101 in configuration 900, then there will be a ramp voltage gradient across resistive sheet 101 in one dimension. The ramp is an example of a first order voltage gradient. A zero-th order gradient, or uniform voltage, may be created by applying the same voltage on both electrodes (905 and 906) of the resistive sheet. In another example, by applying a high, then a low voltage to each of electrodes 905 and 906 for a short time (e.g., approximately one half of an RC time constant of resistive sheet 101) will create a single one-dimensional hump voltage gradient in the middle of resistive sheet 101 that is uniform in an orthogonal direction. This hump is a second order voltage gradient. It is appreciated that these and other voltage gradients can be established on resistive sheets which are configured with more than two electrodes. In devices with more than 2 electrodes even more gradient modes can be applied including saddle shaped gradients, multi-humped gradients, and the like.

Any capacitive disturbance such as a finger will contributed an amount of charge dependent on the voltage at (or integrated over) its effect. Consider the ramp voltage gradient described above. In the ramp voltage gradient, the moment of the capacitance about the center of the ramp would be measured. The farther from the center that a finger contacted resistive sheet 101, the more charge would be changed due to a constant capacitance. By exciting both electrodes to the same voltage (or only exciting a single electrode) the total capacitance (and the change in total capacitance) can be measured. In many embodiments the total capacitance of the sheet is much greater than the coupling to the user input, and measuring it or reducing it relative to the input (e.g. by guarding) is desirable. Higher order distributions than the first order distribution of the ramp voltage gradient allow higher spatial resolution of the effect of the capacitance introduced by an object such as a finger. A variety of measurements of differing gradients can be used to distinguish different user input object locations relative to resistive sheet 101.

### Example Electronic Apparatus

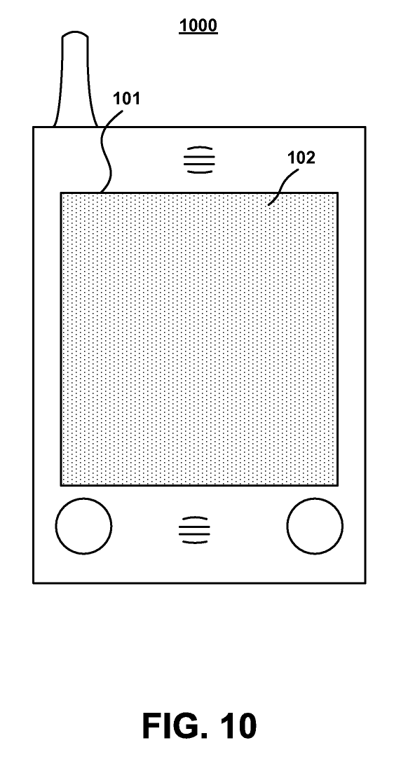

FIG. 10 shows an example electronic apparatus 1000 configured with a sensing device, such as capacitive sensing device 100, which capacitively determines position information about a user input relative to a resistive sheet 101. In this embodiment, electronic apparatus 1000 is an apparatus such as a personal digital assistant, a media player, a computing device, a telephone, or other electronic apparatus. As shown, resistive sheet 101 is transparent layer deposited over an LCD of apparatus 1000 in a thickness which allows for substantial repetitive contact from a user input object such as a finger or stylus. In other embodiments resistive sheet 101 can be disposed in other or additional locations of electronic apparatus 1000 besides the LCD of apparatus 1000. It is appreciated that example electronic apparatus 1000 is intended to be a non-limiting example of the use of the capacitive sensing devices described herein, and that capacitive sensing devices as described herein may be used with other electronic apparatus.

### Capacitively Determining Position Information about a User Input Relative to a Resistive Sheet

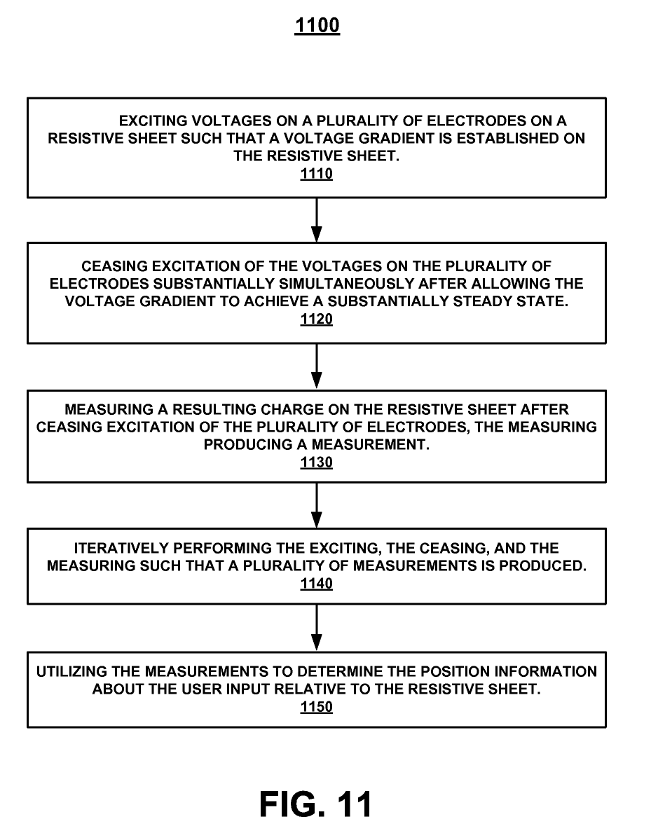

FIG. 11 is a flow diagram 1100 of a method for capacitively determining position information about a user input relative to a resistive sheet, according to one embodiment. Reference will be made to the capacitive sensing device 100 of FIG. 1A in description offlow diagram 1100.

With reference to flow diagram 1100, in 1110, in one embodiment, the method excites voltages on a plurality of electrodes on a resistive sheet such that a voltage gradient is established on the resistive sheet. For example, with reference to FIG. 1A, in one embodiment, this comprises exciting voltages on edge regions of resistive sheet 101, such as by exciting voltages on electrodes 105, 106, 107, and 108, which are in corner regions of resistive sheet 101.

In 1120, in one embodiment, after allowing the voltage gradient to achieve a substantially steady state, the method ceases excitation of the voltages on the plurality of electrodes substantially simultaneously. As previously described, in one embodiment, substantially simultaneously ceasing the excitation comprises ceasing the application on all of the electrodes within a time span of substantially less than one RC time constant of the resistive sheet used in the capacitive sensing device. In one embodiment, this constitutes ceasing the application of the excitation voltages in a time that is approximately one tenth or less of the RC time constant of the resistive sheet used in the capacitive sensing device.

In 1130, in one embodiment, the method measures a resulting charge on the resistive sheet after ceasing excitation of the plurality of electrodes. This measuring produces a measurement in the form of a voltage. With reference to FIG. 1A, in one embodiment, one of the electrodes, such as electrode 105 is also used as a sensing node (e.g., sensing node 110) to measure the resulting charge. For example, the resulting charge is measured by removing the charge from resistive sheet 101 and coupling it to charge integrator 130 for integration into a measured voltage V_{OUT}. As shown in FIG. 1A, in one embodiment, the resulting charge on the resistive sheet is measured using no more that one sensing node coupled between charge integrator 130 and resistive sheet 101. Additionally, in one embodiment, as illustrated by FIG. 1A, no more than one charge integrator is required for measuring the resulting charge.

In 1140, in one embodiment, the method iteratively performs the exciting (1110), the ceasing (1120), and the measuring (1130) such that a plurality of measurements is produced. In one embodiment, iteratively exciting the electrodes comprises exciting the electrodes, such as electrodes 105, 106, 107, and 108 of capacitive sensing device 100, in a selective fashion such that a plurality of substantially different voltage gradients is established. For example, on a succession of excitation iterations, by altering voltage applied, impedance applied, or voltage not applied, timing of voltage application or other parameter(s) (either independently or in combination) a variety of different voltage gradients can be established during a user input relative to the resistive sheet. A plurality of instances of measurement that result from such a plurality of substantially different voltage gradients can then be used in determining position information. These different measurements assist in performing a variety of measurements which can be used in differentiating size and/or location of a user input object (or a plurality of objects) contacting or proximate to resistive sheet 101. As previously described, in one embodiment, only a single charge integrator, such as charge integrator 130, is required to perform the measuring during the measuring (1130).

In 1150, in one embodiment, the method utilizes the measurements to determine the position information about the user input relative to the resistive sheet. For example, with reference to FIG. 1A, the measurements are provided to position information reconstructor 140 which then performs operations to determine position information, such as a one-dimensional or two-dimensional location of a user input object relative to resistive sheet 101. As described above, in some embodiments, the position information which is determined can also comprise differentiating the size of a user input object, or a number and corresponding locations of a plurality of user input objects.

In one embodiment, the method illustrated by flow diagram 1100 also comprises filtering the plurality of measurements to assist in determining a single position. For example, when the resistive sheet is excited several times with a single excitation configuration during a user contact event, the resulting measurements can be filtered, demodulated, and/or averaged to reduce noise or electromagnetic interference.

In the case of demodulation different gradients may alternate, and be demodulated. For example two gradients of opposite sign may be demodulated to remove a common mode signal, or two gradients of different voltage (e.g. all applied voltages at Vdd and all applied voltages at GND) may be demodulated to remove noise.

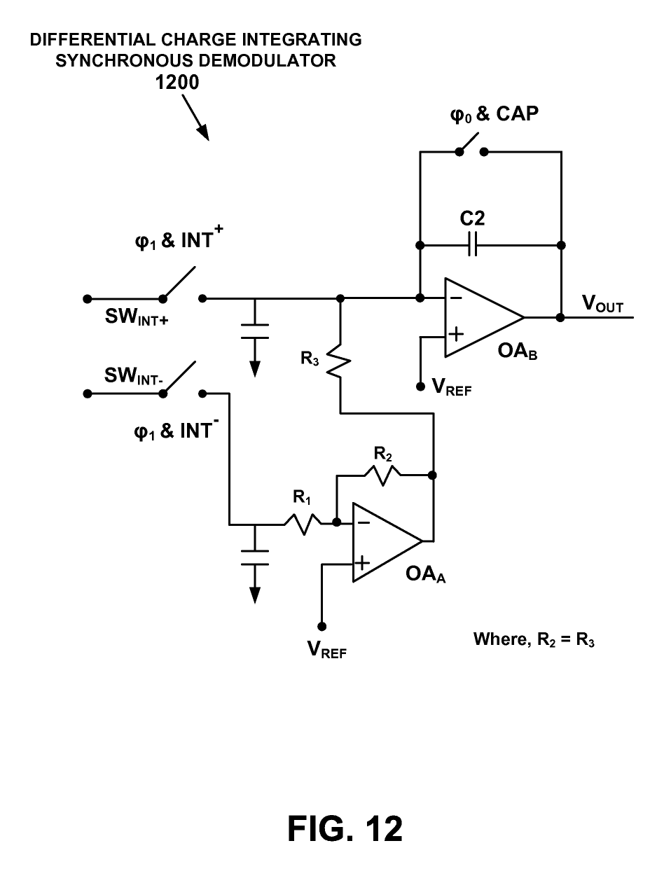

FIG. 12 shows a schematic of an example differential charge integrator used as a synchronous demodulator 1200 according to one embodiment. Synchronous demodulator 1200 incorporates the functions of a charge integrator (e.g. charge integrator 130 shown in various incarnations above) along with a demodulator into a single component/circuit. For purposes of example and not of limitation, in one embodiment charge integrator 1200 can be used in place of charge integrator 130 of FIG. 6B. It is appreciated that like components and figure elements are the same as those in FIG. 6B. It is appreciated that V_{OUT} shown in FIG. 12 can be demodulated separately in one embodiment instead of incorporating the functions of a demodulator with those of a charge integrator. With respect to FIG. 12, the circuit shows a first operational amplifier, OA_{A} which receives an input from the resistive sheet through R₁ on its inverting input when switch SW_{INT-} is closed. The non-inverting input of OA_{A} is coupled with V_{REF}. The output of OA_{A} is fed back to the input of OA_{A} through resistor R₂ and is also coupled to the inverting input of OA_{B} through resistor R₃. R₂ and R₃ are selected with the same resistance value. A second operational amplifier, OA_{B}, receives an input from the resistive sheet on its inverting input when switch SW_{INT+} is closed. The non-inverting input of OA_{B} is coupled with V_{REF}. V_{OUT} is taken from the output of operational amplifier OA_{B}. C2 can be discharged to V_{OUT} by closing a switch across C2 when both CAP and φ₀ are high.

Operation of the circuit shown in FIG. 12 is described with reference to FIG. 4 and to resistive sheet 101 of FIG. 6B. During positive integration cycles, where for example a gradient is established by placing IO₀₀ in a high state and IO₁₁ in a low state (IO₀₁ and IO₁₀ may be at a high impedance state), the charge on the resistive sheet would be accumulated on capacitor C2 by closing SW_{INT+} during the period where both INT+ and φ₁ are high. During negative integration cycles, where for example a gradient is established by placing IO₀₀ in a low state and IO₁₁ in a high state (IO₀₁ and IO₁₀ may be at a high impedance state), the charge on the resistive sheet would be accumulated on capacitor C2 by closing SW_{INT-} during the period where both INT− and φ₁ are high. Notice that SW_{INT-} and SW_{INT+} are also closed on φ₁ and INT− or φ₁ and INT+ respectively, in order to integrate the differential charge.

### Creating a Capacitive Sensing Device

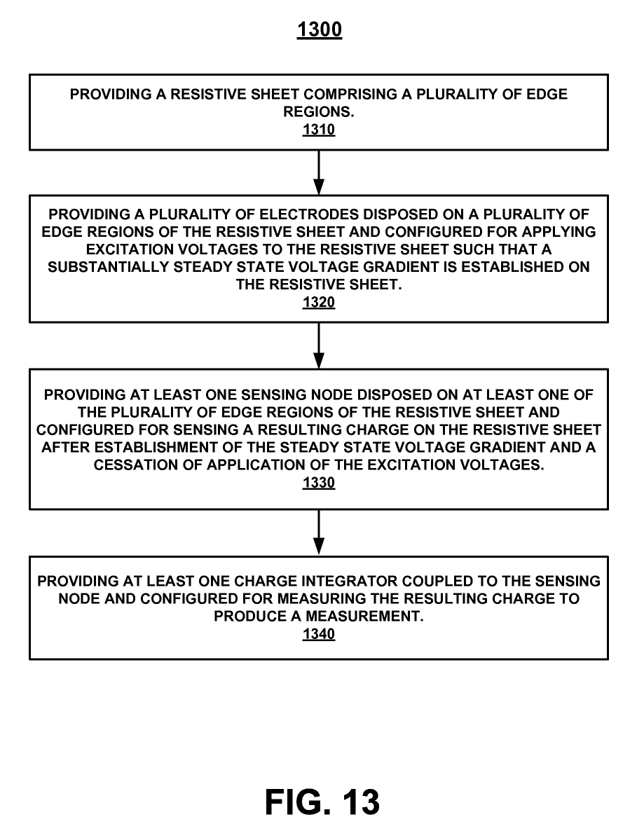

FIG. 13 is a flow diagram 1300 of a method for creating a capacitive sensing device, according to one embodiment. Reference will be made to the capacitive sensing device 100 of FIG. 1A in description of flow diagram 1300. The providing steps described below can be performed by a manufacturer, assembler, or supplier of a capacitive sensing device or product containing a capacitive sensing device.

In 1310, in one embodiment, the method provides a resistive sheet, such as resistive sheet 101 of capacitive sensing device 100.

In 1320, in one embodiment, the method provides a plurality of electrodes, such as electrodes 105, 106, 107, and 108 (shown in FIG. 1) disposed on at least one of the plurality of edge regions of the resistive sheet. The electrodes can be disposed on opposite sides, as shown in FIG. 9, on peripheral side edge region mid-points, on corner edge regions, on other edge regions, or combinations of edge regions. The plurality of electrodes is configured for applying excitation voltages to resistive sheet 101 such that a substantially steady state voltage gradient can be established on resistive sheet 101.

In 1330, in one embodiment, the method provides at least one sensing node, such as sensing node 110, disposed on one of the plurality of edge regions of the resistive sheet. The sensing node may be co-located with or the same as an electrode. The sensing node is used for and configured for sensing a resulting charge on the resistive sheet after establishment of the substantially steady state voltage gradient and a cessation of application of the excitation voltages.

In 1340, in one embodiment, the method provides at least one charge integrator, such as charge integrator 130, coupled to a sensing node, such as sensing node 110, and configured for measuring a resulting charge on the resistive sheet to produce a measurement.

In one embodiment, the method illustrated by flow diagram 1300 also comprises providing a voltage excitation controller, such as voltage excitation controller 120, which is used for and configured for controlling application of the excitation voltages and for substantially simultaneously ceasing the application of the excitation voltages after establishment of the substantially steady state voltage gradient.

In one embodiment, the method illustrated by flow diagram 1300 also comprises providing a position information reconstructing means, such as position information reconstructor 140, to reconstruct position information about an occurrence of a user input relative to the capacitive sensing device. The position information is reconstructed from one or more measurements (shown as V_{OUT} in FIG. 1), taken during an instance of user input with an object relative to resistive sheet 101.

One method of a position recalculation is the calculation of the centroid of the effect of input capacitance. This involves measuring the additional capacitive coupling of a touch input (e.g. finger) to more than one gradient. By measuring V_{OUT} from multiple gradients, the moments of the changes in the moment caused by the touch input can be measured and weighted by the moments of the established gradients, and a centroid of the input capacitance calculated.

The foregoing descriptions of specific embodiments have been presented for purposes of illustration and description. They are not intended to be exhaustive or to limit the presented technology to the precise forms disclosed, and obviously many modifications and variations are possible in light of the above teaching. The embodiments were chosen and described in order to best explain the principles of the presented technology and its practical application, to thereby enable others skilled in the art to best utilize the presented technology and various embodiments with various modifications as are suited to the particular use contemplated. It is intended that the scope of the present technology be defined by the claims appended hereto and their equivalents.

What is claimed is:

1. A capacitive sensing device for sensing a user input, said device comprising:
a resistive sheet;
a plurality of electrodes disposed on a plurality of edge regions of said resistive sheet and configured for applying excitation voltages to said resistive sheet such that a substantially steady state voltage gradient is established on said resistive sheet;
at least one sensing node disposed on at least one of said plurality of edge regions of said resistive sheet and configured for sensing a resulting charge on said resistive sheet after establishment of said steady state voltage gradient and a cessation of application of said excitation voltages; and
at least one charge integrator coupled to said at least one sensing node and configured for measuring said resulting charge to produce a measurement.

2. The device of claim 1, wherein said at least one sensing node comprises a sensing node which is disposed at a common location with an electrode of said plurality of electrodes.

3. The device of claim 1, wherein said plurality of electrodes comprises electrodes disposed on corner regions of said resistive sheet.

4. The device of claim 1, wherein said plurality edge regions are configured to have a lower average sheet resistance than a central surface region of said resistive sheet.

5. The device of claim 1, further comprising:
a guard electrode disposed behind a side of said resistive sheet which is configured for sensing said user input.

6. The device of claim 1, further comprising:
a voltage excitation controller configured for controlling application of said excitation voltages and substantially simultaneously ceasing the application of said excitation voltages after establishment of said substantially steady state voltage gradient.

7. The device of claim 6, wherein said voltage excitation controller is further configured for selectively controlling application of said excitation voltages through said plurality of electrodes to establish a plurality of substantially different steady state voltage gradients on said resistive sheet.

8. The device of claim 1, further comprising:
a means for utilizing said measurement produced by said charge integrator to reconstruct position information about an occurrence of a user input relative to said device.

9. The device of claim 1, further comprising:
a means for demodulating said measurement produced by said charge integrator.

10. A method for capacitively determining position information about a user input relative to a resistive sheet, said method comprising:
exciting voltages on a plurality of electrodes on said resistive sheet such that a voltage gradient is established on said resistive sheet;
ceasing excitation of said voltages on said plurality of electrodes substantially simultaneously after allowing said voltage gradient to achieve a substantially steady state;
measuring a resulting charge on said resistive sheet after ceasing excitation of said plurality of electrodes, said measuring producing a measurement;
iteratively performing said exciting, said ceasing, and said measuring such that a plurality of measurements is produced; and
utilizing said measurements to determine said position information about said user input relative to said resistive sheet.

11. The method as recited in claim 10, wherein said exciting voltages on a plurality of electrodes on said resistive sheet such that a voltage gradient is established on said resistive sheet comprises:
exciting voltages on said plurality of electrodes, said plurality of electrodes located on edge regions of said resistive sheet.

12. The method as recited in claim 10, wherein said ceasing excitation of voltages on said plurality of electrodes substantially simultaneously after allowing said voltage gradient to achieve a substantially steady state comprises:
ceasing excitation of said voltages on said plurality of electrodes within a time period substantially shorter than one time constant of said resistive sheet.

13. The method as recited in claim 10, wherein said measuring a resulting charge on said resistive sheet after ceasing excitation of said plurality of electrodes comprises:
measuring said resulting charge using one of said plurality of electrodes as a sensing node.

14. The method as recited in claim 10, wherein said measuring a resulting charge on said resistive sheet after ceasing excitation of said plurality of electrodes comprises:
measuring said resulting charge using a charge integrator.

15. The method as recited in claim 14, wherein said measuring a resulting charge on said resistive sheet after ceasing excitation of said plurality of electrodes comprises:
measuring said resulting charge using no more than one sensing node coupled between said resistive sheet and said charge integrator.

16. The method as recited in claim 10, further comprising:
filtering said plurality of measurements to assist in determining a single position.

17. The method as recited in claim 10, wherein said iteratively performing said exciting comprises:
exciting said electrodes in a selective fashion such that a plurality of substantially different voltage gradients is established on said resistive sheet on a succession of excitation iterations performed during said user input relative to said resistive sheet.

18. The method as recited in claim 17, wherein said utilizing said measurements to determine said position information about said user input relative to said resistive sheet comprises:
using a plurality of instances of said measurement resulting from said plurality of substantially different voltage gradients.

19. The method as recited in claim 10, wherein measuring a resulting charge on said resistive sheet after ceasing excitation of said plurality of electrodes comprises:
after an iteration of said exciting and said ceasing, utilizing only a single charge integrator in measuring said resulting charge on said resistive sheet to produce said measurement.

20. An electronic apparatus configured with a sensing device which capacitively determines position information about a user input relative to a resistive sheet, said apparatus comprising:
a resistive sheet;
a plurality of electrodes disposed on a plurality of edge regions of said resistive sheet;
a voltage excitation controller configured for applying excitation voltages through a plurality of said electrodes to said resistive sheet such that a substantially steady state voltage gradient is established on said resistive sheet;
at least one sensing node disposed on at least one of said edge regions of said resistive sheet;
a charge integrator configured for measuring a resulting charge on said resistive sheet through said at least one sensing node such that a measurement of said resulting charge is produced, said measuring performed after establishment of said substantially steady state voltage gradient and a cessation of application of said excitation voltages; and
a position information reconstructor configured for utilizing said measurement to reconstruct position information about said user input relative to said resistive sheet.

21. The apparatus of claim 20, wherein said voltage excitation controller is further configured for substantially simultaneously ceasing application of said excitation voltages after establishment of said substantially steady state voltage gradient.

22. The apparatus of claim 20, wherein said position information reconstructor is further configured to reconstruct said position information from a plurality of measurements produced by said charge integrator during a time span of said user input relative to said resistive sheet.

23. A method for creating a capacitive sensing device, said method comprising:
providing a resistive sheet comprising a plurality of edge regions;
providing a plurality of electrodes disposed on at least one of said plurality of edge regions of said resistive sheet and configured for applying excitation voltages to said resistive sheet such that a substantially steady state voltage gradient is established on said resistive sheet;
providing at least one sensing node disposed on said plurality of edge regions of said resistive sheet and configured for sensing a resulting charge on said resistive sheet after establishment of said steady state voltage gradient and a cessation of application of said excitation voltages; and
providing at least one charge integrator coupled to said sensing node and configured for measuring said resulting charge to produce a measurement.

24. The method as recited in claim 23, further comprising:
providing a voltage excitation controller configured for controlling application of said excitation voltages and substantially simultaneously ceasing the application of said excitation voltages after establishment of said substantially steady state voltage gradient.

25. A capacitive sensing device for sensing a user input, said device comprising:
a resistive sheet;
a means for applying excitation voltages to said resistive sheet such that a substantially steady state voltage gradient is established on said resistive sheet;
a means for sensing a resulting charge on said resistive sheet after establishment of said substantially steady state voltage gradient and a cessation of application of said excitation voltages; and
a means for measuring said resulting charge to produce a measurement.

26. The device of claim 25, further comprising
a means for controlling application of said excitation voltages and substantially simultaneously ceasing the application of said excitation voltages after establishment of said substantially steady state voltage gradient.
